(19) United States
(12) Patent Application Publication
(10) Pub. No.: US 2012/0235616 A1
(43) Pub. Date: Sep. 20, 2012

(54) POSITION SENSING SYSTEM FOR A THREE (3) PHASE ELECTRIC MOTOR

(75) Inventor: Andrew Meyer, Fortville, IN (US)

(73) Assignee: REMY TECHNOLOGIES, L.L.C., Pendleton, IN (US)

(21) Appl. No.: 13/050,406

(22) Filed: Mar. 17, 2011

(51) Int. Cl. H02K 29/08

(52) U.S. Cl. 318/400.39

(57) ABSTRACT

A multi-phase electric motor including a housing, a stator mounted to the housing, a rotor rotatably mounted relative to the stator, and a position sensing system configured and disposed to output a signal representing a position of the rotor relative to the stator. The position sensing system includes a rotating member mounted relative to the rotor and a plurality of digital sensors mounted relative to the rotating member. At least two of the plurality of digital sensors are configured and disposed to generate a quadrature output signal. The plurality of digital sensors being configured and disposed to sense discrete portions of the rotating member to detect a position of the rotor relative to the stator.

### BACKGROUND OF THE INVENTION

Exemplary embodiments pertain to the art of electric motors and, more particularly, to a position sensing system for a three-phase electric motor.

It is desirable to know rotor position relative to a stator of a multi-phase electric machine before activation. Knowledge of the rotor position enables the multi-phase electric machine to be activated in such away so as to achieve a desired direction of rotation. In addition, it is desirable to monitor rotor position to allow for proper timing of current. That is, applying current when the rotor is in a particular position range relative to the stator results in maximum output torque. Without proper timing, the multi-phase motor will perform poorly, operate in a reverse direction, or not operate at all.

Current systems for monitoring motor position include rotary encoders and resolvers. Rotary encoders are electro-mechanical devices that convert angular position of a rotor shaft to an analog or digital code. Generally, rotary encoders include an encoder housing that is mounted externally to the multi-phase electric motor. Rotary encoders include both mechanical encoders and optical encoders. Mechanical encoders include a metal disc containing a concentric rings of openings fixed to an insulating disk that is rigidly mounted to the rotor shaft. A row of sliding contacts is fixed to a stationary object, such as the encoder housing, such that each contact wipes against the metal disc at a different distance from the shaft. The contacts signal a presence or absence or material on the metal disc to provide electric signals that are representative of shaft position. Optical encoders employ discs made from glass or plastic having transparent and opaque areas. A light source directs light at the disc and a photo-detector reads optical patterns passing through the disc to provide signals representative of shaft position.

Resolvers are rotary transformers that are mounted to a multi-phase electric motor. A brushless transmitter resolver includes a stator and a rotor. The stator includes three windings, an exciter winding and two-phase windings. The exciter winding forms part of a transformer. The two phase windings are arranged 90 degrees offset from the exciter winding. A sinusoidal electric current is induced into the exciter winding. The current flows to the two-phase windings producing a sinusoidal and cosine feedback current each having an associated voltage. The relative magnitude of the two voltages is measured to determine an angle of the rotor relative to the stator.

### BRIEF DESCRIPTION OF THE INVENTION

Disclosed is a multi-phase electric motor including a housing, a stator mounted to the housing, a rotor rotatably mounted relative to the stator, and a position sensing system configured and disposed to output a signal representing a position of the rotor relative to the stator. The position sensing system includes a rotating member mounted relative to the rotor and a plurality of digital sensors mounted to the housing relative to the rotating member. At least two of the plurality of digital sensors are configured and disposed to generate a quadrature output signal. The plurality of digital sensors being configured and disposed to sense discrete portions of the rotating member to detect a position of the rotor relative to the stator.

Also disclosed is a method of sensing a position of a rotor relative to a stator of a multi-phase electric motor. The method includes digitally sensing with a first digital sensor a first trigger element arranged on a first sensing portion of a rotating member mounted to the rotor of the multi-phase electric motor. The first trigger element includes a first sensing portion and a first transition portion. The method also includes sensing with a second digital sensor a second trigger element arranged on the first sensing portion. The second trigger element is ninety degrees out of phase relative to the first trigger element. A quadrature output signal having a quadrature signal period is generated from the first and second digital sensors. The method further includes digitally sensing with a third digital sensor a trigger member arranged on a second sensing portion of the rotary member, generating an output signal from the third digital sensor, and determining a position of the rotor relative to the stator based on the quadrature signal and the output signal from the third digital sensor.

Further disclosed is a position sensing system for sensing a position of a rotor relative to a stator. The position sensing system includes a rotating member, and a plurality of digital sensors mounted relative to the rotating member. At least two of the plurality of digital sensors being configured and disposed to generate a quadrature output signal. The plurality of digital sensors are configured and disposed to sense discrete portions of the rotating member to detect a position of the rotor relative to the stator.

### BRIEF DESCRIPTION OF THE DRAWINGS

The following descriptions should not be considered limiting in any way. With reference to the accompanying drawings, like elements are numbered alike:

FIG. 1 depicts a cross-sectional view of an three phase electric motor including a position sensing system in accordance with an exemplary embodiment;

FIG. 2 depicts a plan view of the position sensing system of FIG. 1;

FIG. 3 depicts a detail view of a portion of the position sensing system of FIG. 2; and

FIG. 4 depicts output signals from the position sensing system in accordance with an exemplary embodiment.

### DETAILED DESCRIPTION OF THE INVENTION

A detailed description of one or more embodiments of the disclosed apparatus and method are presented herein by way of exemplification and not limitation with reference to the Figures.

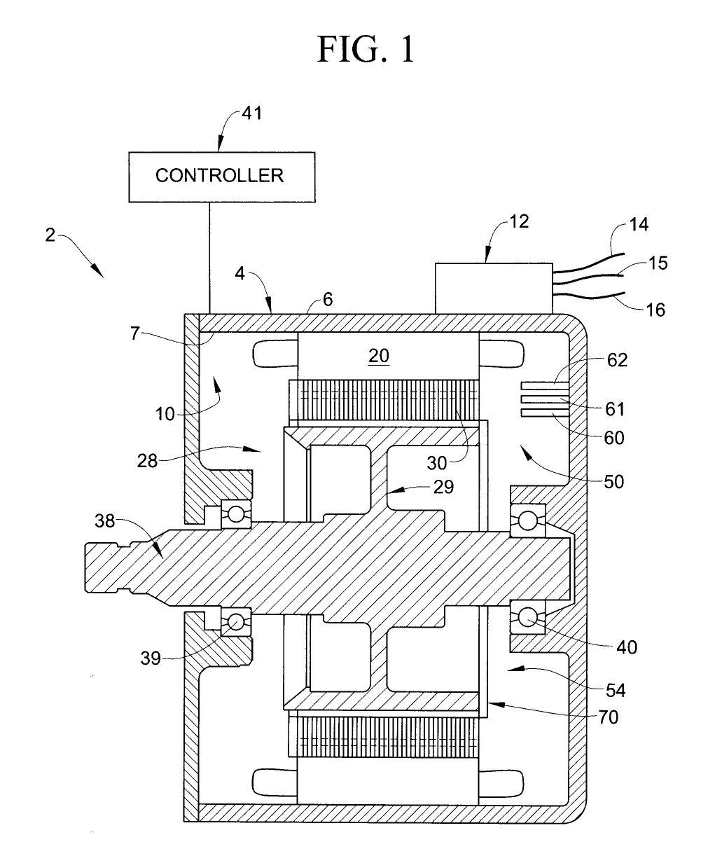

FIG. 1 illustrates an electric machine, shown in the form of a multi-phase electric motor 2, in accordance with an exemplary embodiment. As will be detailed more fully below, multi-phase electric motor 2 takes the form of a three-phase electric motor. Multi-phase electric motor 2 includes a housing 4 having an outer surface 6 and an inner surface 7 that defines an interior portion 10. A connector housing 12 is mounted to outer surface 6. A plurality of electric supply cables 14-16 pass into connector housing 12. Multi-phase electric motor 2 is also shown to include a stator 20 operatively connected to inner surface 8 of housing 4 and electrically connected to the plurality of electric supply cables 14-16. More specifically, stator 20 includes a plurality of stator phase windings (not separately labeled) electrically connected to electric supply cables 14-16. That is, stator 20 includes a first phase stator phase winding connected to electric supply cable 14, a second stator phase winding connected to electric supply cable 15, and a third stator phase winding connected to electric supply cable 16. A rotor 28 is rotatably mounted within interior portion 10. Rotor 28 includes a rotor hub 29 that supports a plurality of rotor laminations 30 that are rotated relative to stator 20. Rotor laminations 30 include a plurality of rotor phase windings (not separately labeled). More specifically, rotor laminations 30 include a first rotor phase winding, a second rotor phase winding and a third rotor phase winding. An output shaft 38 is mounted to rotor hub 29. Output shaft 38 is supported by first and second bearings 39 and 40 and provides a mechanical interface to a driven member (not shown).

Multi-phase electric motor 2 is electrical connected to a controller 41 that establishes a desired rotational speed, and rotational direction for rotor 28. However, prior to any application of current to multi-phase electric motor 2, it is desirable to sense a position of rotor 28 relative to stator 20. Sensing a relative position of rotor 28 to stator 20 allows controller 41 to initially apply current to a desired one of the stator phase windings. In addition to initial current application, controller 41 establishes a desired current timing. That is, controller 41 applies current when rotor 28 is in a particular position range relative to stator 20 in order to produce a desired output torque from multiphase electric motor 2. In order to sense the position of rotor 28 relative to stator 22, multi-phase electric motor 2 includes a position sensing system 50.

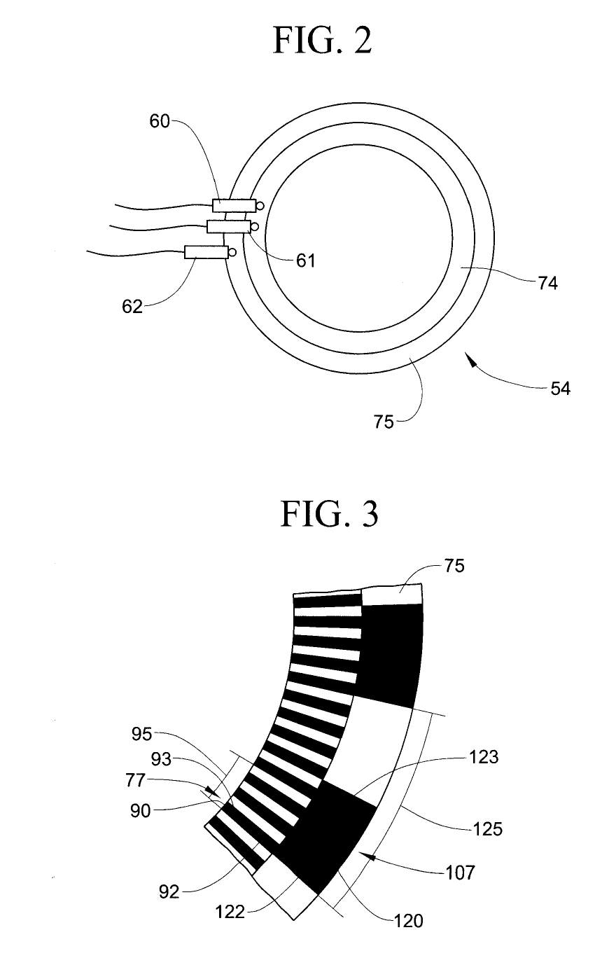

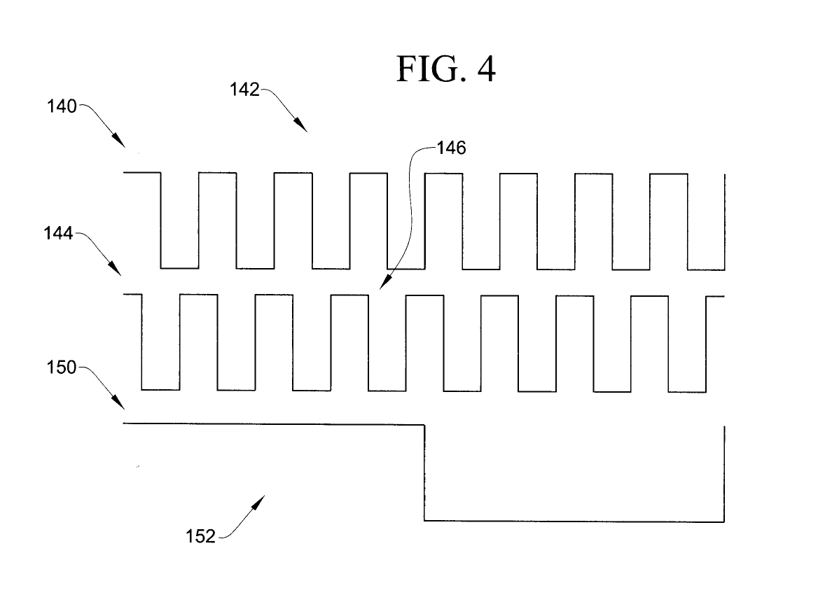

In accordance with an exemplary embodiment, position sensing system 50 includes a rotary member 54 and a plurality of digital sensors 60-62 fixedly mounted relative to housing 4 and electrically connected to controller 41. As best shown in FIGS. 2 and 3, rotary member 54 takes the form of a tone wheel 70 having a first sensing portion 74 and a second sensing portion 75. First sensing portion 74 includes a plurality of trigger elements, one of which is indicated at 77 that are positioned at the first and second rotor phases. Each trigger element 77 includes a sensing portion 90 having a first transition portion 92, and a second transition portion 93. Trigger elements 77 collectively establish a 50% duty cycle that indicates a position of the first rotor phase and the second rotor phase to establish a quadrature sensing period 95. More specifically, digital sensors 60 and 61 take the form of, for example, Hall Effect sensors that are positioned to detect trigger elements 77. Digital sensor 61 is arranged about 90° out of phase relative to digital sensor 60. With this arrangement, as tone wheel 70 rotates digital sensor 60 detects sensing portions 90 to produce a first quadrature output signal 140 having a first quadrature period 142, and digital sensor 61 detects sensing portions 90 to produce a second quadrature output signal 144 having a second quadrature period 146 such as shown in FIG. 4 and in the Table 1 below. In accordance with one aspect of the exemplary embodiment, trigger elements 77 are arranged to produce first and second quadrature sensing signals 140 and 144 having eight (8) cycles per phase. With digital sensor 61 being 90° out of phase relative to digital sensor 60 quadrature output signals provide position accuracy of about 11.25° for the first and second rotor phases

TABLE 1

| Sensor 60 | Sensor 61 |
|---|---|
| 1 | 1 |
| 0 | 1 |
| 0 | 0 |
| 1 | 0 |

In further accordance with the exemplary embodiment, second sensing portion 75 extends concentrically about first sensing portion 74 and includes a plurality of trigger members 107 that are closely aligned with the third rotor phase. Each trigger members 107 includes a sensing section 120 having a first transition section 122 and a second transition section 123 that collectively establish a sensing period 125. In accordance with the exemplary embodiment, first transition section 122 is closely aligned with one of the first transition portions 92 of trigger elements 77. Digital sensor 62 is positioned to detect sensing sections 120 to produce an output signal 150 having an output signal period 152 that in accordance with one aspect of the exemplary embodiment is less than each of quadrature output periods 142 and 144. In accordance with another aspect of the exemplary embodiment, output signal period 152 is an integer multiple of quadrature output periods 142 and 146. In this manner, a positive output from digital sensor 62 aligns with applied force of the third rotor phase in one direction (e.g., clockwise) and a negative output from digital sensor 62 aligns with applied force of the third rotor phase in an opposite direction (e.g., counter-clockwise) to increase position detection accuracy of position sensing system 50.

In the above described arrangement, output from digital sensor 60 aligns with output from digital sensor 62 to provide controller 41 with position indication that allows for proper current application to achieve desired torque output. While position accuracy may be lower during a first portion of rotor movement leading to a slight reduction of torque at initial start-up, after a first transition of signal 150, position sensing system signals precise rotor position to controller 41. Thus following only a small rotation of rotor 28, full motor capability is available. If multi-phase electric motor is used as power for a vehicle, full motor capability would be available after only a few centimeters of movement.

At this point, it should be understood that position sensing system 50 provides a low cost system for detecting rotor position of a multi-phase motor. In addition to low cost, the position sensing system in accordance with the exemplary embodiment has a small form factor. That is, in contrast to existing resolvers and encoders that increase a size of a motor assembly, the position sensing system in accordance with the exemplary embodiment allows for the design and construction of smaller multi-phase electric motors having without sacrificing operating characteristics. It should also be understood that while described as Hall Effect sensors, the digital sensors can take on a variety of forms. Furthermore, while described as including three digital sensors with one sensor closely aligned with a rotor phase winding, additional accuracy could be realized with the addition of a fourth sensor closely aligned with another of the rotor phase windings.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

What is claimed is:

1. A multi-phase electric motor comprising:
a housing;
a stator mounted to the housing;
a rotor rotatably mounted relative to the stator; and
a position sensing system configured and disposed to output a signal representing a position of the rotor relative to the stator, the position sensing system including a rotating member mounted relative to the rotor and a plurality of digital sensors mounted to the housing relative to the rotating member, at least two of the plurality of digital sensors being configured and disposed to generate a quadrature output signal, the plurality of digital sensors being configured and disposed to sense discrete portions of the rotating member to detect a position of the rotor relative to the stator.

2. The multi-phase electric motor according to claim 1, wherein the plurality of digital sensors include first, second, and third digital sensors, the first digital sensor being ninety degrees out of phase with the second digital sensor and the third digital sensor being configured to align with a rotor phase winding.

3. The multi-phase electric motor according to claim 2, wherein the first and second digital sensors are configured and disposed to establish the quadrature output signal.

4. The multi-phase electric motor according to claim 2, wherein the rotating member comprises a tone wheel having a first sensing portion and a second sensing portion.

5. The multi-phase electric motor according to claim 4, wherein the first sensing portion includes a plurality of trigger elements aligned with the first and second digital sensors, each of the plurality of trigger elements including a sensing portion and a transition portion that collectively establish a quadrature sensing period for the first and second digital sensors.

6. The multi-phase electric motor according to claim 5, wherein the second sensing portion includes a plurality of trigger members aligned with the third digital sensor, each of the plurality of trigger members includes a sensing section and a transition section that collectively establish a sensing period for the third digital sensor, the sensing section being aligned with a rotor phase winding.

7. The multi-phase electric motor according to claim 6, wherein the sensing period for the third digital sensor is less than the quadrature sensing period of the first and second digital sensors.

8. The multi-phase electric motor according to claim 7, wherein the sensing period for the third digital sensor in an integer multiple of the quadrature sensing period.

9. The multi-phase electric motor according to claim 7, wherein the transition section of each of the plurality of trigger members is substantially aligned with one of the transition portions of the plurality of trigger elements.

10. The multi-phase electric motor according to claim 4, wherein the second sensing portion extends concentrically about the first sensing portion.

11. The multi-phase electric motor according to claim 1, wherein each of the plurality of digital sensors comprises a Hall Effect sensor.

12. A method of sensing a position of a rotor relative to a stator of a multi-phase electric motor, the method comprising:
digitally sensing with a first digital sensor a first trigger element arranged on a first sensing portion of a rotating member mounted to the rotor of the multi-phase electric motor, the first trigger element including a first sensing portion and a first transition portion;
digitally sensing with a second digital sensor a second trigger element arranged on the first sensing portion, the second trigger element being ninety degrees out of phase relative to the first trigger element;
generating quadrature output signal having a quadrature signal period from the first and second digital sensors;
digitally sensing with a third digital sensor a trigger member arranged on a second sensing portion of the rotary member;
generating an output signal from the third digital sensor; and
determining a position of the rotor relative to the stator based on the quadrature signal and the output signal from the third digital sensor.

13. The method of claim 12, wherein generating the output signal includes generating an output signal having an output signal period that is less than the quadrature signal period.

14. The method of claim 12, wherein digitally sensing the third digital signal includes sensing a transition element of the trigger member aligned with a transition portion of one of the first and second trigger members.

15. A position sensing system for sensing a position of a rotor relative to a stator comprising:
a rotating member; and
a plurality of digital sensors mounted relative to the rotating member, at least two of the plurality of digital sensors being configured and disposed to generate a quadrature output signal, the plurality of digital sensors being configured and disposed to sense discrete portions of the rotating member to detect a position of the rotor relative to the stator.

16. The position sensing system according to claim 15, wherein the plurality of digital sensors include first, second, and third digital sensors, the first digital sensor being ninety degrees out of phase with the second digital sensor and the third digital sensor being configured to align a rotor phase winding.

17. The position sensing system according to claim 16, wherein the rotating member comprises a tone wheel having a first sensing portion and a second sensing portion.

18. The position sensing system according to claim 17, wherein the first sensing portion includes a plurality of trigger elements aligned with the first and second digital sensors, each of the plurality of trigger elements including a sensing portion and a transition portion that establishes a quadrature sensing period for the first and second digital sensors.

19. The position sensing system according to claim 18, wherein the second sensing portion includes a plurality of trigger members aligned with the third digital sensor, each of the plurality of trigger members includes a sensing section and a transition section that establishes a sensing period for the third digital sensor, the sensing section being configured and disposed to align with the one of a plurality of phases of a multi-phase electric motor.

20. The position sensing system according to claim 19, wherein the transition section of each of the plurality of trigger members is substantially aligned with one of the transition portions of the plurality of trigger elements.
